(19) United States
(12) Patent Application Publication
(10) Pub. No.: US 2005/0047268 A1
(43) Pub. Date: Mar. 3, 2005

(54) Stirrer

(76) Inventor: Chun Yong Chen, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/648,225

(22) Filed: Aug. 27, 2003

(51) Int. Cl. B01F 1/00; B01F 13/00

(52) U.S. Cl. 366/129; 366/343

(57) ABSTRACT

An improved structure of stirrer is applicable to mixing up liquid, it is provided with a circular disc having peripherally thereof with a plurality of blades inserted therein in a mutually spaced and inclined way, and a shank of which one end is combined with the center of a surface of the circular disc; thereby, when the stirrer is using, liquid can enter from gaps between every two blades around the circular disc and discharge from an upper and a lower opening in order that liquid can be agitated and blended adequately.

### BACKGROUND OF THE INVENTION

1. Field of the Invention

The present invention is related to an improved structure of stirrer, and especially to an improved structure of stirrer of which one end of a shank is provided with a circular disc having peripherally thereof a plurality of blades inserted therein in a mutually spaced and inclined way to adequately agitate and mix up liquid, it is particularly suitable for mixing up liquid such like paint.

2. Description of the Prior Art

Since general builders need paints to beautify buildings, there are many kinds of paints. For example, ready-mixed paint consists of long oil alkyd resin and weather-resistant pigments, the principal ingredients of enamel paint for spray painting are medium oil alkyd resin and weather-resistant pigments, the principal ingredients of water-base masonry paint are resins excellent in water-resistance and alkaline-resistance as well as special pigments, the principal ingredient of oil-base masonry paint is acrylic resin excellent in alkaline-resistance, and emulsion paint is refined from copolymer resin of emulsified polyvinyl acetate (PVAC) and alkaline-resistant pigments. The abovementioned kinds of paints are properly applied respectively in different sites, such as for general indoor/outdoor iron and wood constructions, and for protection and decoration etc. of interior/exterior walls of cement constructions. However, paint is a composition of pigments and resin liquid, it probably needs a period of time for the process from well mixing-up to using and is hard to avoid segregation and sediment of pigments, thereby the paint should be adequately stirred and mixed till it is completely uniform before use, and shall be kept on stirring during work period.

A conventional stirrer 10 can have many kinds of more advanced designs, it can be formed from a barrel-shaped exhaust fan (usually seen on the market) of which the blades are formed by inserting rods directly; as shown in FIG. 1, a circular disc 20 provided peripherally from the top to the bottom thereof with a plurality of equally spaced arc blades 30. Therefore, when the stirrer is using, paint enters from an upper and a lower central opening above and below the circular disc 20 respectively and discharges from gaps between every two arc blades 30. Although the effect of such agitating and blending is better by virtue of the small and many gaps of the blades, as a result, too many stained dead corners forming, this will render a brush not easy to extend to those frames 40 provided on and beneath the abovementioned blades 30, and thus make the clean-up after use not easy. If for the situation of agitating and blending for only one color, its effect is really very good; however, it is probable that a number of colored paints are to be mixed up in site, thus although this conventional way of agitating and blending is fast, since it has to take much more time to clean up in order not to generate blended colors, the conventional way is inconvenient in operation.

In view of the flaws of the abovementioned conventional techniques, the present invention is developed.

### SUMMARY OF THE INVENTION

The primary object of the present invention is to provide an improved structure of stirrer with very good flow disturbing effect as well as easiness and convenience for cleaning up.

To achieve the abovementioned object of the present invention, the improved structure of stirrer of the present invention being applied to mixing up liquid comprises: a circular disc provided peripherally thereof with a plurality of blades inserted therein in a mutually spaced and inclined way; and a shank of which one end is combined with the center of a surface of the circular disc; thereby when the stirrer is processing, liquid enters from gaps between every two blades around the circular disc and discharges from an upper and a lower opening in order that the liquid can be agitated and blended adequately.

The present invention will be apparent after reading the detailed description of a preferred embodiment thereof in reference to the accompanying drawings.

### BRIEF DESCRIPTION OF THE DRAWINGS

FIG. 1 is a perspective view showing a conventional paint stirrer;

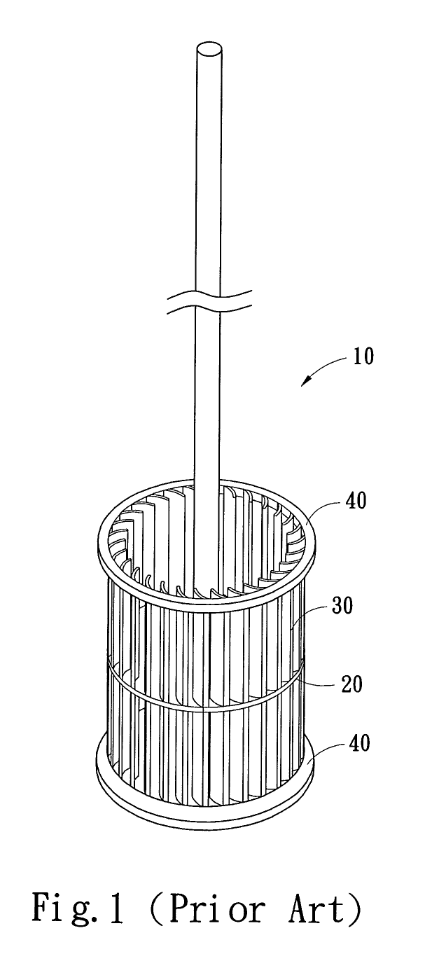

FIG. 2 is a perspective view showing the stirrer of the present invention;

FIG. 3 is a top view showing the appearance of the stirrer of the present invention;

FIG. 4 is a schematic perspective view showing directions of liquid flowing in using the stirrer of the present invention.

### DETAILED DESCRIPTION OF THE PREFERRED EMBODIMENT

The improved structure of stirrer of the present invention comprises primarily: a circular disc 50 for receiving blades 60, and a shank 70 connecting with the circular disc 50.

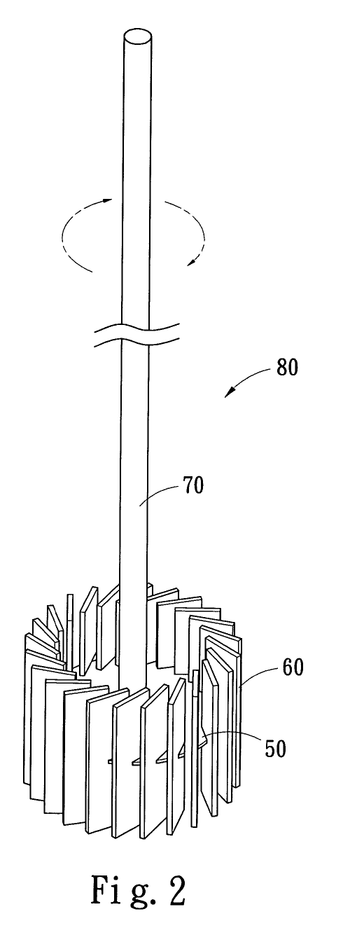

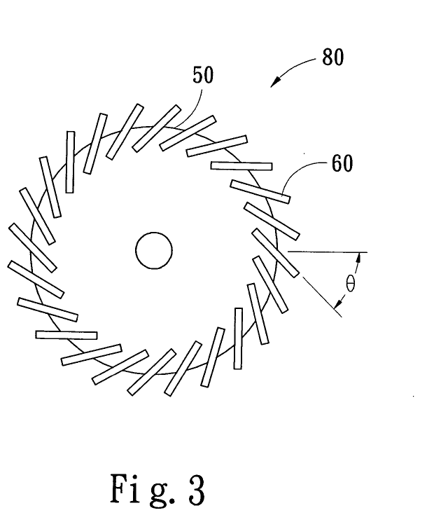

Referring to FIGS. 2 and 3 depicting the improved structure of a stirrer 80 of the present invention, the structure comprises: a circular disc 50 provided peripherally thereof with a plurality of blades 60 inserted therein in a mutually spaced and inclined way, the blades 60 are rectangular flat plates, and can be welded to or integrally formed with the circular disc 50 in production; and a shank 70 of which one end is combined with the center of a surface of the circular disc 50.

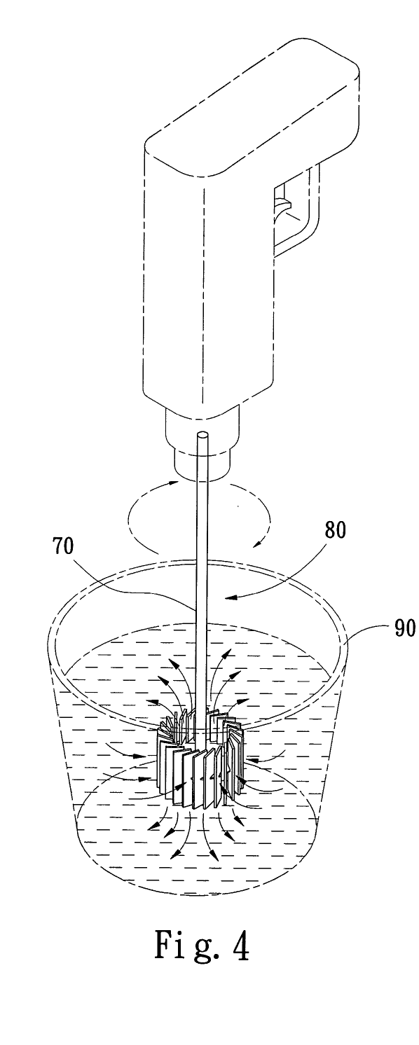

After combining, the blades 60 have no frame thereon nor therebeneath to be in an open state and easy for cleaning up, in addition, the blades 60 are upright, broad and flat, they can generate powerful agitating effects. Moreover, when the blades 60 are inserted in an inclined way, as shown by a θ angle in FIG. 3, they are arranged in a radiation mode deviating form 40 to 50 degrees from corresponding normal lines anticlockwise leftwards around the shank 70. Thus, as shown in FIG. 4, when the stirrer 80 agitates paint, the directions of flowing paint goes from the gaps between every two blades 60 in the shapes of flat plates around the circular disc 50 and enters into and discharges from the upper and the lower openings in order that paint in a stirrer barrel 90 can be agitated and blended adequately.

Therefore, the present invention has the following advantages:
1. Because the blades of the present invention are flat plates with no frame, they are easy for cleaning up without taking much time.
2. On account of using blades in the shapes of flat plates, when the stirrer is using, the direction of flowing liquid goes through the gaps between every two blades to be absorbed in and discharged upwardly, stirring with such a flowing direction gains more uniform agitating effects.

In conclusion, according to the contents disclosed above, the present invention can surely obtain the expected object to provide an improved structure of stirrer with an extreme practical value.

Although this invention has been disclosed and illustrated with reference to a particular embodiment, it is not for giving any limitation to the scope of the present invention. It will be apparent to those skilled in this art that various changes and modifications without departing from the spirit of this invention shall fall within the scope of the appended claims.

1. An improved structure of stirrer comprising: a circular disc and a shank;
said circular disc is provided peripherally thereof with a plurality of blades inserted therein in a mutually spaced and inclined way;
said shank has one end thereof combined with the center of a surface of said circular disc;
therefore, when said stirrer is running, liquid enters from gaps between every two of said blades around said circular disc and discharges upwardly to be blended adequately.

2. The improved structure of stirrer as in claim 1, wherein length of each of said blades is adapted to being added to increase function of agitating.

3. The improved structure of stirrer as in claim 1, wherein material of said structure is stainless steel.

4. The improved structure of stirrer as in claim 1, wherein said blades are in shapes of rectangular flat plates.

5. The improved structure of stirrer as in claim 1, wherein said blades are integrally formed with said circular disc, said blades inserted in an inclined way are arranged in a radiation mode deviating from 40 to 50 degrees to corresponding normal lines anticlockwise around said shank.
